(19) United States
(12) Patent Application Publication
(10) Pub. No.: US 2006/0196259 A1
(43) Pub. Date: Sep. 7, 2006

(54) Aerial of wireless tire pressure monitoring device

(76) Inventors: Chin-Yao Hsu, Tanzih Township (TW); Hung-Chih Yu, Taichung City (TW); Feng-Yi Chang, Tanzih Township (TW); Yu-Hsing Hsiao, Wuzih Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/068,815

(22) Filed: Mar. 2, 2005

(51) Int. Cl. B60C 23/02

(52) U.S. Cl. 73/146.8

(57) ABSTRACT

A wireless tire pressure monitoring device has a detecting device and an air tap bonded to the detecting device. The detecting device has a flat box, in which an emitting circuit board is received, and a lid to close the box, and the air tap has a tube, a cover on a free end of the tube and a bolt, in which air flows, to secure an end the tube on a middle section of the box of the detecting device, such that the detecting device and the air tap are mounted between a rim and a tire. An aerial is embedded in the box of the detecting device to combine the aerial and the box as a single element.

### BACKGROUND OF THE INVENTION

1. Field of the Invention

The present invention relates generally to a tire pressure monitoring device, and more particularly to a wireless tire pressure monitoring device, which has a longer aerial to emit an electric signal to a receiver in a predetermined distance to monitor the tire pressure.

2. Description of the Related Art

In early time, drivers had to identify the tire pressure by a pressure meter. The pressure meter has to be mated to the tap of a tire to detect the tire pressure that could not monitor the tire pressure in driving to put the driver in a danger condition. The improved device is the wireless tire pressure monitoring device, which includes a receiver and an emitter. The emitter mounted in the tire to emitting signals of the tire pressure to the receiver mounted in the car to monitor the tire pressure and temperature of the specific tire in anytime. In practice, the emitter emits a radio signal when the tire pressure or the temperature of the tire beyond a normal range. The receiver receives the signal from the emitter and tells the driver which tire has problem by audio or video. FIG. 6 and FIG. 7 show a conventional wireless tire pressure monitoring device, which includes a printed circuit board (PCB) 6 and an aerial 7 mounted on the PCB 6. The aerial the conventional tire pressure monitoring device has drawbacks hereunder:

1. The aerial 7, which is made of copper, is bonded on the PCB 6 by welding. The aerial 7 is rectangular and short (typical is 30 mm) to prevent it from break or failure in the welding portion by vibration. This aerial 7 also makes short when it is loosen or shifted by vibration.

2. The tire pressure monitoring system (SPMT) is asked to have a smaller size and a lighter weight as possible. The PCB 6 usually has not enough space for a long aerial, such that only the short aerial 7 is available. But the short aerial 7 has a poor capacity in emitting signal.

3. The short aerial 7 emits a weak signal in a narrower range that the receiver might have a false identification of the signal. Besides, it takes more electrical power to emit a strong signal via the short aerial 7 that increases the power consumption of the battery.

4. Except that the short aerial 7 take more power, the battery of the emitter is not replaceable by a normal person. The power consumption of the emitter is a major issue of the TPMS.

5. The short aerials 7 can not be mounted on the PBC 6 by surface mount technology (SMT) that they have to be processed by manipulation. The aerial 7 has a three-dimension shape so that they have to be clipped by a specific holder for welding. The welding process might be failure but you can not tell from the perspective view thereof. As a result, the new product with the fail welding may still work because of the new battery, but the durability and the quality of the products are decreased therefore. In conclusion, it is a difficult job to assemble the short aerial 7, and the cost of fabrication is increased therefore.

### SUMMARY OF THE INVENTION

The primary objective of the present invention is to provide a wireless tire pressure monitoring device, which is easier and faster in assembly and has a lower power consumption and a correct detection to protect the driver.

According to the objective of the present invention, a wireless tire pressure monitoring device has a detecting device and an air tap bonded to the detecting device. The detecting device has a flat box, in which an emitting circuit board is received, and a lid to close the box, and the air tap has a tube, a cover on a free end of the tube and a bolt, in which air flows, to secure an end the tube on a middle section of the box of the detecting device, such that the detecting device and the air tap are mounted between a rim and a tire. An aerial is embedded in the box of the detecting device to combine the aerial and the box as a single element.

### BRIEF DESCRIPTION OF THE DRAWINGS

FIG. 1 is a perspective view of a preferred embodiment of the present invention;

FIG. 2 is an exploded view of the preferred embodiment of the present invention;

FIG. 3 is a sectional view of the preferred embodiment of the present invention;

FIG. 4 is a perspective view of the preferred embodiment of the present invention, showing inside of the box;

FIG. 5 is a perspective view of the preferred embodiment of the present invention in application, and

FIG. 6 and FIG. 7 show perspective views of the conventional wireless tire pressure monitoring device.

### DETAILED DESCRIPTION OF THE INVENTION

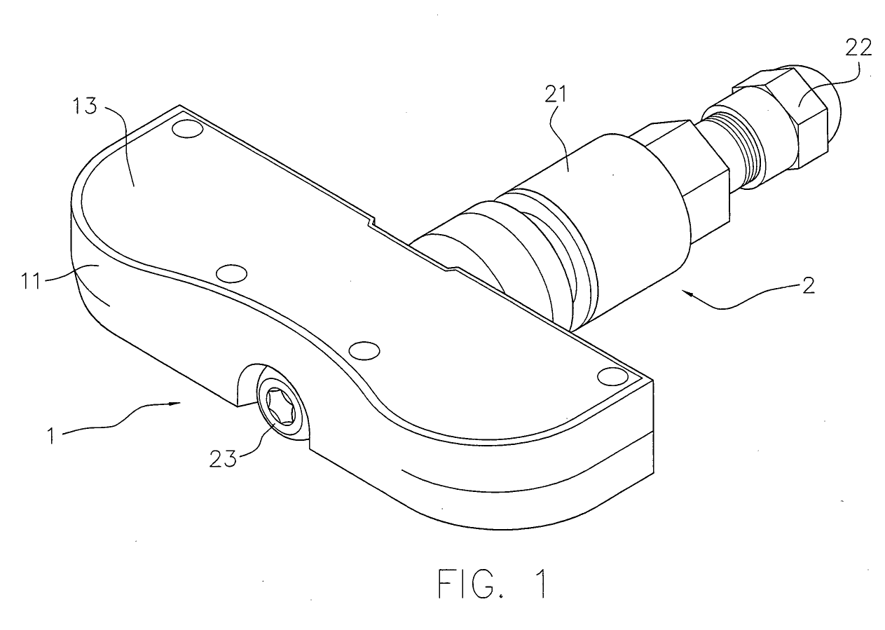

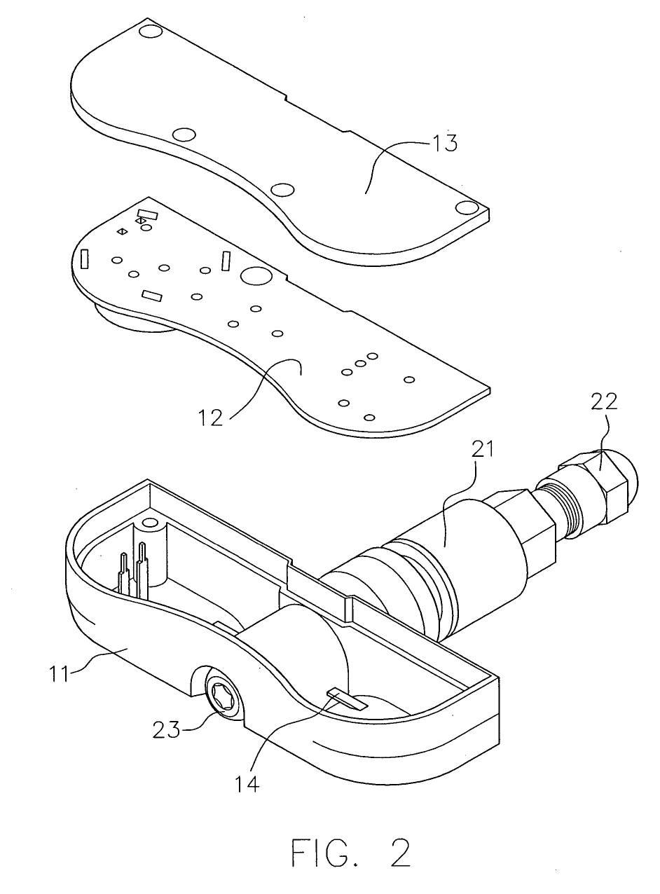

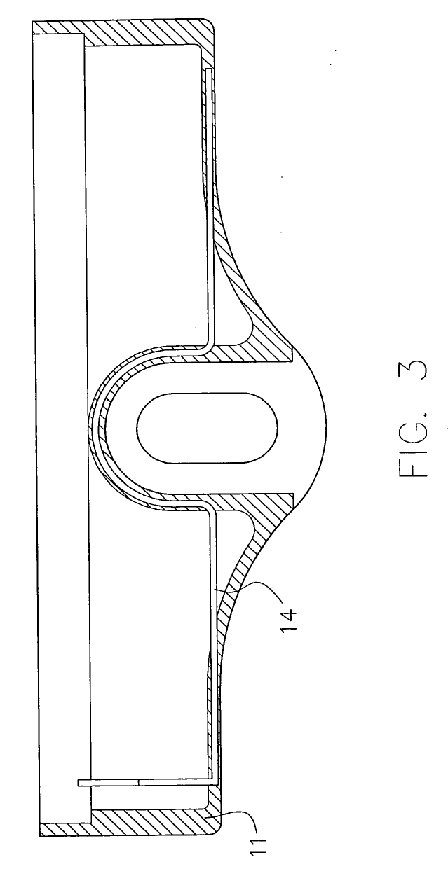

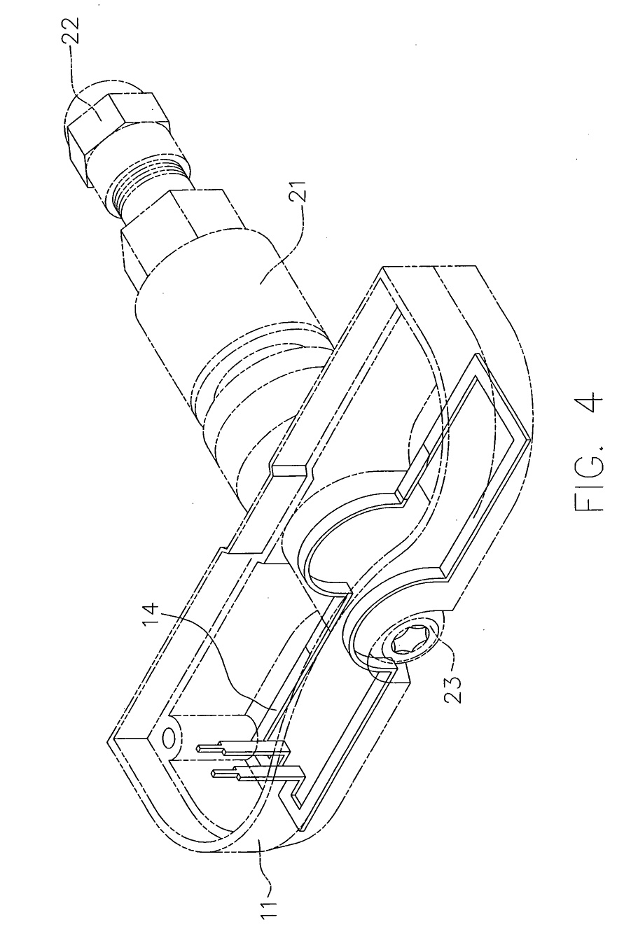

As shown in FIG. 1 to FIG. 5, a wireless tire pressure monitoring device of the preferred embodiment of the present invention comprises a detecting device 1 and an air tap 2 bonded to the detecting device 1. The detecting device 1 has a flat box 11, in which an emitting circuit board 12 is received, and a lid 13 to close the box 11. The air tap 2 has a tube 21 and a cover 22 screwed on a free end of the tube 21. A bolt 23, in which air flows, secures an end the tube 23 on a middle section of the box 11 of the detecting device 1. The detecting device 1 and the air tap 2 are mounted between a rim 3 and a tire 4.

An aerial 14 is embedded in a bottom wall of the box 11 of the detecting device 1 to combine the aerial 14 and the box 11 as a single element, such that the process of fabrication is easier and the accuracy of detection is increased. The aerial 14 is a rectangular frame and has an arched portion at a middle section to be mated with the box 11. The major portion of the aerial 14 is embedded in the box 11 but it has exposed portions at sections thereof adjacent to the arched portion and at two ends to be connected to the emitting circuit board 12.

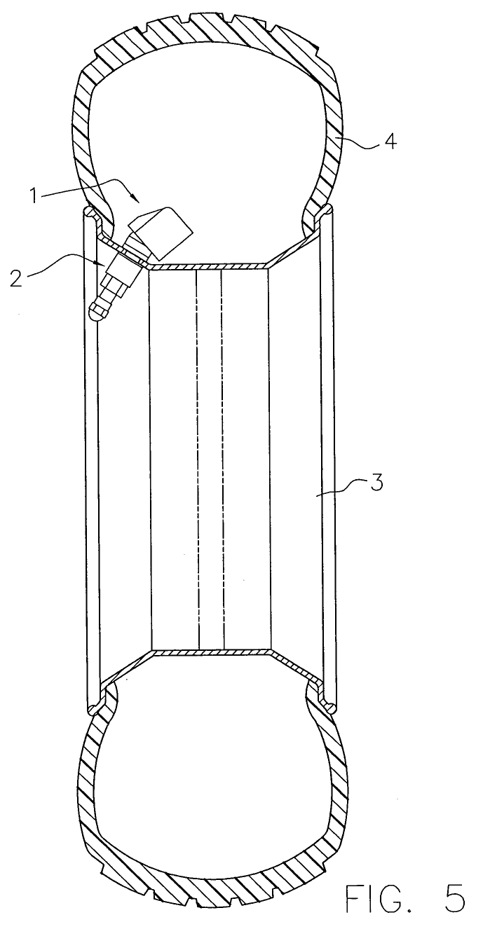

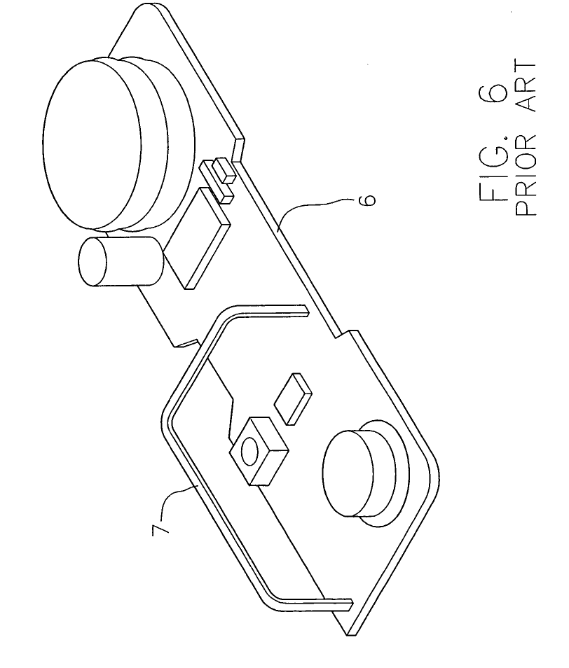

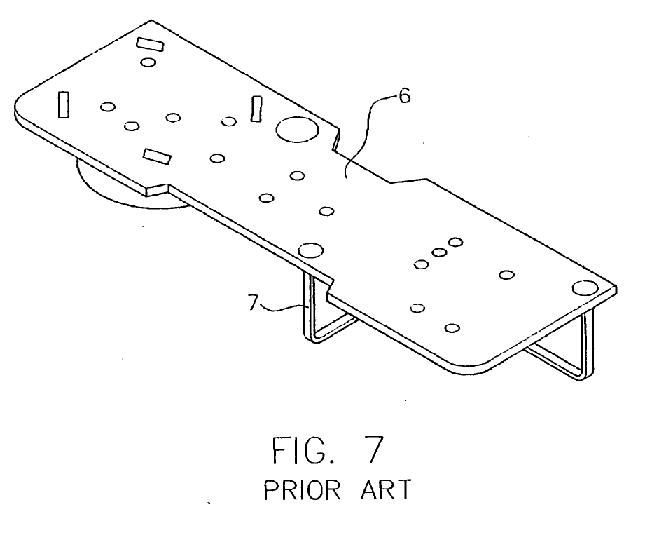

The present invention provides a faster process of fabrication. The aerial 14 is made in the box at initial by injection molding to have a single element. And then, the emitting circuit board 12 is mounted in the box and electrically connected to the aerial 14 via the exposed portions. The box 11 is covered with the lid 13 and is connected to the air tap 2 to complete the wireless tire pressure monitoring device of the present invention. Finally, wireless tire pressure monitoring device of the present invention is installed between the rim 3 and the tire 4, as shown in FIG. 5.

The present invention overcomes the drawbacks of the conventional device, and they are described hereunder:

1. The tire pressure monitoring device has to pass the vibration test and the durability test to make sure that the components thereof are not loosen in real driving. The aerial of the present invention is firmly bonded to the box as a single element, such that the tire pressure monitoring device of the present invention can pass any test. It is bonded to the PCB and other electric devices firmly also, so that the aerial of the present invention has less risk of loosing or shifting that might cause short than the conventional aerial.

2. The aerial embedded in the box is not restricted by the shape and space of the box and there is no space issue as the conventional device, such that the box can be reduced its size thereof but still keeps the aerial with a sufficient length. The length of the aerial of the present invention is 160 mm that is five times longer than the convention aerial.

3. With the longer aerial, the present invention can provide the signal to a longer distance with a higher accuracy than the conventional device, furthermore, the power consumption is reduced to have the battery working for a longer time and meet the requirements of manufacturers and consumers.

4. The longer aerial increases the intensity of the signal emitted from the emitting circuit board and reduces the power consumption that is a key point of TPMS. The wireless tire pressure monitoring device is asked to have a lower power consumption, greater intensity of signal and higher accuracy of data because that a normal person can not disassemble the wireless tire pressure monitoring device from the tire.

5. The aerial and the box are made as a single element at initial, such that there is no process to assemble the aerial and there is no defective product occurred in quality control process. It needs no the test procedure that reduces time of test, cost of labor, equipment and test.

6. There are fewer pieces for the wireless tire pressure monitoring device of the present invention that advantages the material manage.

The advantages of the present invention are:

1. The aerial of the present invention passes any test of the product and does not interfere with any other electric devices or cause short. The length of the aerial is longer then the conventional aerial to increase the intensity of signal and the accuracy of data in wireless transmission.

2. It reduces the space in the box for the aerial and to increase the length of the aerial.

3. The aerial is five time longer than the conventional aerial that increases the intensity of signal, the accuracy of data, the distance of signal transmission, the life of battery to meet the requirements of manufacturers and consumers.

4. The longer aerial reduces the power consumption to meet the requirement of TPMS.

5. It reduces the error in assembly to reduce the test procedure and the ratio of defective, the cost of labor and the cost of assembly and quality control. It prevents the aerial from break or shift by vibration in real driving and from short.

6. It reduces the pieces of device to decrease the cost of the material manage.

What is claimed is:

1. A wireless tire pressure monitoring device, comprising a detecting device and an air tap bonded to the detecting device, wherein the detecting device has a flat box, in which an emitting circuit board is received, and a lid to close the box, and the air tap has a tube, a cover on a free end of the tube and a bolt, in which air flows, to secure an end the tube on a middle section of the box of the detecting device, such that the detecting device and the air tap are mounted between a rim and a tire; an aerial embedded in the box of the detecting device to combine the aerial and the box as a single element.

2. The wireless tire pressure monitoring device as defined in claim 1, wherein the aerial is a rectangular frame and has an arched portion at a middle section to be mated with the box.

3. The wireless tire pressure monitoring device as defined in claim 1, wherein the aerial has exposed portions to be connected to the emitting circuit board.

4. The float switch as defined in claim 2, wherein the aerial has exposed portions at ends thereof and at sections adjacent to the arch portion to be connected to the emitting circuit board.
